(19) United States
(12) Patent Application Publication
(10) Pub. No.: US 2026/0323330 A1
(43) Pub. Date: Oct. 15, 2026

(54) PROCESSING METHOD FOR MEASUREMENT, AND TERMINAL DEVICE AND NETWORK DEVICE THEREOF

(71) Applicant: GUANGDONG OPPO MOBILE TELECOMMUNICATIONS CORP., LTD., Dongguan (CN)

(72) Inventor: Jinqiang XING, Dongguan (CN)

(21) Appl. No.: 19/463,923

(22) Filed: Jan. 29, 2026

Related U.S. Application Data
(63) Continuation of application No. PCT/CN2023/127365, filed on Oct. 27, 2023.

(51) Int. Cl. H04W 24/08; H04W 24/10; H04W 72/044

(52) U.S. Cl. CPC H04W 24/08; H04W 24/10; H04W 72/044

(57) ABSTRACT

Provided is a processing method for measurement. The method is performed by a terminal device, and includes: receiving configuration information, wherein the configuration information is used to configure a measurement resource for the terminal device, the measurement resource being a time-frequency resource where no downlink signal is present; and acquiring a measurement result by measuring a received signal based on the measurement resource, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

### CROSS-REFERENCE TO RELATED APPLICATION

This application is a continuation of International Application No. PCT/CN2023/127365, filed Oct. 27, 2023, the entire disclosure of which is incorporated herein by reference.

### TECHNICAL FIELD

Embodiments of the present disclosure relate to the technical field of mobile communications, and in particular, relate to a processing method for measurement, and a terminal device and a network device thereof.

### RELATED ART

Receiver sensitivity degradation refers to deterioration in receiver sensitivity of a terminal due to impacts caused due to factors such as interference or noise.

### SUMMARY

Embodiments of the present disclosure provide a processing method for measurement, and a terminal device and a network device thereof. The technical solutions are as follows.

According to some embodiments of the present disclosure, a processing method for measurement is provided. The method is performed by a terminal device, and includes: receiving configuration information, wherein the configuration information is used to configure a measurement resource for the terminal device, and the measurement resource is a time-frequency resource where no downlink signal is present; and acquiring a measurement result by measuring a received signal based on the measurement resource, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

According to some embodiments of the present disclosure, a terminal device is provided. The terminal device includes a processor, a memory and a transceiver; wherein the memory is configured to store one or more computer programs, and the processor is configured to load and run the one or more computer programs to cause the terminal device to: receive configuration information, wherein the configuration information is used to configure a measurement resource for the terminal device, the measurement resource being a time-frequency resource where no downlink signal is present; and acquire a measurement result by measuring a received signal based on the measurement resource, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

According to some embodiments of the present disclosure, a network device is provided. The network device includes a processor, a memory and a transceiver; wherein the memory is configured to store one or more computer programs, and the processor is configured to load and run the one or more computer programs to cause the network device to: transmit configuration information to a terminal device, wherein the configuration information is used to configure a measurement resource for the terminal device, the measurement resource being a time-frequency resource where no downlink signal is present; wherein the measurement resource is used by the terminal device to acquire a measurement result by measuring a received signal, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

### BRIEF DESCRIPTION OF DRAWINGS

FIG. 1 is a schematic diagram of a communication system according to some embodiments of the present disclosure;

FIG. 2 is a schematic diagram of harmonic interference and intermodulation interference according to some embodiments of the present disclosure;

FIG. 3 is a schematic diagram of a sensitivity degradation and a network coverage reduction according to some embodiments of the present disclosure;

FIG. 4 is a schematic diagram of an intra-terminal interference path according to some embodiments of the present disclosure;

FIG. 5 is a flowchart of a processing method for measurement according to some embodiments of the present disclosure;

FIG. 6 is a flowchart of a processing method for measurement according to some embodiments of the present disclosure;

FIG. 7 is a flowchart of a processing method for measurement according to some embodiments of the present disclosure;

FIG. 8 is a schematic diagram of a maximum sensitivity degradation (MSD) according to some embodiments of the present disclosure;

FIG. 9 is a schematic diagram of terminal measurement of received signal intensity according to some embodiments of the present disclosure;

FIG. 10 is a schematic diagram of a downlink signal measurement time window according to some embodiments of the present disclosure;

FIG. 11 is a schematic diagram of a downlink signal measurement time-frequency resource according to some embodiments of the present disclosure;

FIG. 12 is a block diagram of a processing apparatus for measurement according to some embodiments of the present disclosure;

FIG. 13 is a block diagram of a processing apparatus for measurement according to some embodiments of the present disclosure; and

FIG. 14 is a schematic structural diagram of a communication device according to some embodiments of the present disclosure.

### DETAILED DESCRIPTION

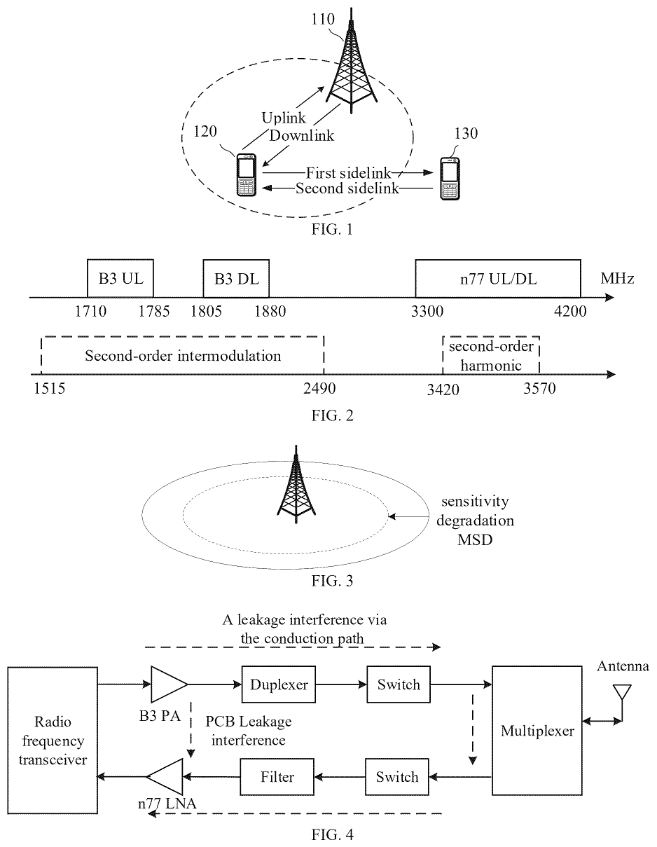

FIG. 1 is a schematic diagram of a communication system involved in some embodiments of the present disclosure. The communication system includes a network device 110 and a terminal device 120, and/or the terminal device 120 and a terminal device 130, which is not limited in the present disclosure.

The network device 110 in the present disclosure provides wireless communication functions. The network device 110 includes but not limited to: an evolved Node-B (eNB), a radio network controller (RNC), a Node-B (NB), a base station controller (BSC), a base transceiver station (BTS), a home base station (e.g., a home evolved Node-B, or a home Node-B, HNB), a baseband unit (BBU), an access point (AP) in a wireless fidelity (Wi-Fi) system, a wireless relay node, a wireless backhaul node, a transmission point (TP) or a transmission reception point (TRP), or the like. The network device 110 may also be a next generation Node-B (gNB) or a transmission point (a TRP or a TP) in a 5^{th} generation (5G) mobile communication system, or one or a set of antenna panels (including a plurality of antenna panels) of a base station in the 5G system, or a network node constituting a gNB or a transmission point, such as a baseband unit (BBU) or a distributed unit (DU), or the like, or a base station in a beyond 5^{th} generation (B5G), a 6^{th} generation (6G) mobile communication system, or the like, or a core network (CN), a fronthaul, a backhaul, a radio access network (RAN), a network slice, or the like, or a serving cell, a primary cell (PCell), a primary secondary cell (PSCell), a special cell (SpCell), a secondary cell (SCell), a neighboring cell, or the like, of the terminal device.

The terminal device 120 and/or terminal device 130 in the present disclosure is also known as a user equipment (UE), an access terminal, a user unit, a user station, a mobile station, a mobile terminal, a remote station, a remote terminal, a mobile device, a user terminal, a terminal, a wireless communication device, a user agent, a user device. The terminal includes but is not limited to: a handheld device, a wearable device, an in-vehicle device, an Internet of things (IoT) device, or the like, including a mobile phone, a tablet, an e-book reader, a laptop, a desktop computer, a television, a game console, a mobile Internet device (MID), an augmented reality (AR) terminal, a virtual reality (VR) terminal, and a mixed reality (MR) terminal, a wearable device, a handle, an electronic tag, a controller, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, a wireless terminal in remote medical surgery, a cellular phone, a cordless phone, a Session Initiation Protocol (SIP) phone, a wireless local loop (WLL) station, a personal digital assistant (PDA), a set-top box (STB), a customer premises equipment (CPE), or the like.

The network device 110 and the terminal device 120 communicate with each other using an air interface technology, for example, a Uu interface.

As an example, the network device 110 and the terminal device 120 are involved in two communication scenarios: an uplink communication scenario and a downlink communication scenario. The uplink communication refers to transmitting signals to the network device 110, and the downlink communication refers to transmitting signals to the terminal device 120.

The terminal device 120 and the terminal device 130 communicate with each other using an air interface technology, for example, a Prose communication 5 (PC5) interface.

In some embodiments, the terminal device 120 and the terminal device 130 are involved in two communication scenarios: a first sidelink communication scenario and a second sidelink communication scenario. The first sidelink communication refers to transmitting signals to the terminal device 130; and the second sidelink communication refers to transmitting signals to the terminal device 120.

Both the terminal device 120 and the terminal device 130 are within a network coverage and located in the same cell, or both the terminal device 120 and the terminal device 130 are within the network coverage but are served by different cells, or the terminal device 120 is within the network coverage whereas the terminal device 130 is outside the network coverage.

The technical solutions according to the embodiments of the present disclosure may be applied to various communication systems, such as a global system of mobile communication (GSM) system, a code-division multiple access (CDMA) system, a wideband code-division multiple access (WCDMA) system, a general packet radio service (GPRS) system, a long-term evolution (LTE) system, an LTE frequency division duplex (FDD) system, an LTE time-division duplex (TDD) system, an advanced long-term evolution (LTE-A) system, a universal mobile telecommunication system (UMTS), a worldwide interoperability for microwave access (WiMAX) communication system, a 5G mobile communication system, a new radio (NR) system, an evolved system of the NR system, an LTE-based access-to-unlicensed spectrum (LTE-U) system, an NR-based access-to-unlicensed spectrum (NR-U) system, a terrestrial network (TN) system, a non-terrestrial network (NTN) system, a wireless local area network (WLAN) system, a wireless fidelity (Wi-Fi) system, a cellular IoT system, a cellular passive Internet of things system, and may also be applied to the subsequent evolution systems of 5G NR system, and may also be applied to B5G, 6G, and subsequent evolution systems. In some embodiments of the present disclosure, “NR” may also be referred to as 5G NR system or 5G system. The 5G mobile communication system may include non-standalone (NSA) and/or standalone (SA).

The technical solutions according to the embodiments of the present disclosure may also be applied to a machine-type communications (MTC), a long-term evolution-machine (LTE-M), a device-to-device (D2D) network, a machine to machine (M2M) network, an IoT network, or other networks. The IoT network may include an Internet of vehicles. The communication methods in the Internet of vehicles system are collectively referred to as vehicle-to-X (V2X, X may represent anything). For example, the V2X may include vehicle-to-vehicle (V2V) communications, vehicle-to-infrastructure (V2I) communications, vehicle-to-pedestrian (V2P) communications, vehicle-to-network (V2N) communications, or the like.

### 1) Mutual Interference and Sensitivity Degradation

Receiver sensitivity degradation refers to deterioration in receiver sensitivity of a terminal due to the impacts caused due to factors such as interference or noise. In NR, various scenarios may cause a sensitivity degradation. A typical scenario is the sensitivity degradation caused by harmonics, harmonic mixing, intermodulation, adjacent channel interference, and the like, such as in cases of EUTRA-NR dual connectivity (EN-DC), NR-EUTRA dual connectivity (NE-DC), DC or carrier aggregation (CA). The following provides a brief introduction using EN-DC as an example.

In related arts, in a case where a terminal transmits and receives data simultaneously over a plurality of frequency bands, intra-terminal interference may be present. This may lead to a reduction in receive performance of the terminal, consequently resulting in receiver sensitivity degradation.

Typically, intra-terminal mutual interference is primarily caused due to non-linearity of radio frequency (RF) front components, such as a power amplifier (PA) and the like. In a case where an input signal is a single-tone signal cos(wt), an output signal includes higher-order harmonic components such as 2 wt, 3 wt, and the like. Harmonic interference occurs in a case where the harmonics fall within the receive frequency band. The interference often occurs in scenarios where low-frequency transmission and high-frequency reception are performed simultaneously.

In a case where a transmit frequency of a terminal over one frequency band (band A) is an integer multiple of a receive frequency over another frequency band (band B), the harmonics of a local oscillator (LO) in a receiver for band B in the terminal may receive a transmit signal leaked from the band A to the receiver for band B in the terminal. Consequently, signal-to-noise ratio (SNR) of the received signal is degraded.

In a case where the input signal includes a plurality of frequency components, the output signal may include various orders of intermodulation products of the plurality of frequency components. Taking two input frequency components, cos(ω₁t) and cos(ω₂t), as an example, the output signal may include second-order intermodulation (ω₁±ω₂), third-order intermodulation (2ω₁±ω₂, ω₁±2ω₂), or the like. The intermodulation interference may occur in a case where these intermodulation products fall into the receive frequency band. The interference often occurs in scenarios involving simultaneous transmission on high and low frequency bands or in scenarios where external signals ingress into the transmit link of the UE.

Additionally, in a case where the transmit frequency of one frequency band and the receive frequency of another frequency band are relatively close, insufficient isolation of a filter may cause the transmit signal from one frequency band to interfere with the receive signal of another frequency band, resulting in adjacent-band interference.

Taking mutual interference between B3 and n77 as an example, as illustrated in FIG. 2, which is a schematic diagram of harmonic interference and intermodulation interference involved in the present disclosure, the second-order harmonic of the B3 uplink causes harmonic interference to the n77 downlink, and the second-order intermodulation product generated by the B3 uplink and the n77 uplink causes interference to the B3 downlink receive.

In NR, the harmonic interference and the intermodulation interference cause severe impacts on the receive performance of the terminal. The impact of the second-order harmonic and the second-order intermodulation products, in particular, may lead to sensitivity degradation reaching several tens of decibels (dB). This results in a significant reduction of the downlink receive coverage of the terminal. A schematic diagram of the sensitivity degradation and the network coverage reduction involved in the present disclosure is illustrated in FIG. 3. In standards, sensitivity degradation (i.e., MSD) is typically defined to accommodate different interferences. The MSD characterizes a maximum allowable degradation in downlink receive capabilities of the terminal for band combinations where interference may be present, as prescribed in the standard.

### 2) Generation Paths of Mutual Interference and Countermeasures

In an RF design, as illustrated in FIG. 4, which is a schematic diagram of an intra-terminal interference path involved in the present disclosure, in addition to the interference coupled backward via a transmit link and a receive link of the terminal, interference directly leaking via a printed circuit board (PCB) into another branch may also affect the generation of the harmonic interference and the intermodulation interference. In FIG. 4, a second harmonic generated by a B3 transmit link of the terminal interferes with a 3.5 GHz receiver via both a conducted path and a PCB leakage path.

With respect to leakage interference via the conducted path, filters are typically added to the RF path to suppress the harmonic interference and the intermodulation interference or the like. With respect to PCB leakage interference, additional processing such as optimizing the PCB layout and isolation is required. However, this is highly dependent on the design of the terminal, and the ultimate interference suppression situation may vary significantly across different terminals. Consequently, in practice, the sensitivity degradation caused by interference may not be as severe as the worst-case scenario evaluated in the standards, but is typically better than the MSD value defined in the standard.

### 3) MSD Reporting

Since the actual interference in a terminal may not be as severe as that defined in the standard, a mechanism has been introduced to allow the terminal to report its actual interference intensity capability. This facilitates the base station in evaluating the actual interference situation of the terminal to further optimize scheduling strategies, such as determining whether to configure a band combination with high interference for a specific terminal. For example, a terminal device may measure its band combinations subject to interference during the research and development process and report an actual sensitivity degradation value of each band combination as a terminal capability to the base station. The problem with this approach is that the number of band combinations supported by a terminal device is usually very large (typically up to 1000 band combinations). Furthermore, a plurality of types of interference (such as both harmonic interference and intermodulation interference as illustrated in FIG. 2) may exist under a single band combination. This makes MSD reporting a massive engineering undertaking and results in a large amount of reported information, rendering it practically unusable in actual networks.

As mentioned in the above section, the current 3GPP standards define the MSD for band combinations (e.g., LTE B3+NR n77) subject to the harmonic interference and intermodulation interference, to allow the terminal to perform the sensitivity degradation. As long as the sensitivity degradation value of the terminal is less than the MSD, the terminal is considered to satisfy the requirements. However, for some band combinations, the MSD value is relatively large. For example, as illustrated in FIG. 2, the MSD may reach 20 dB or even more in a case where second-order harmonic interference or second-order intermodulation interference occurs. For the band combinations, even in a case where a UE satisfies the MSD requirement, the band combinations may not be effectively utilized in actual networks. This is because the base station does not know the actual sensitivity degradation value of the terminal, but only infers the interference situation of users within the cell under the band combinations based on the MSD defined in the 3GPP standards. A worse case is that the base station may not use the band combinations due to severe interference.

Currently, a solution that allows the terminal to report its actual MSD for each frequency band has been proposed. However, due to high implementation complexity for the terminal and the large amount of reported information, the solution is practically unusable in actual networks.

This technical solution may avoid reporting the MSD as a terminal capability. Instead, the solution achieves reporting of interference intensity by means of measuring the interference intensity of the specific band combinations used by the terminal within the network.

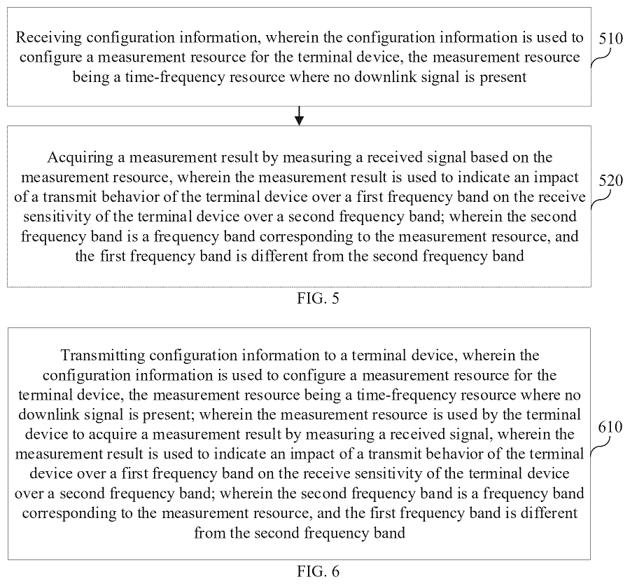

FIG. 5 is a flowchart of a processing method for measurement according to some embodiments of the present disclosure. The method may be performed by a terminal device. The terminal device may be the terminal device 120 or the terminal device 130 in the network architecture illustrated in FIG. 1. The method may include the following steps.

In S510, the terminal device receives configuration information, wherein the configuration information is used to configure a measurement resource for the terminal device, the measurement resource being a time-frequency resource where no downlink signal is present.

In S520, the terminal device acquires a measurement result by measuring a received signal based on the measurement resource, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

In summary, in the technical solutions according to the embodiments of the present disclosure, regarding two operating frequency bands in which the terminal device operates, the network device may configure the time-frequency resource where no downlink signal is present as the measurement resource for the terminal device. The terminal device may measure the received signal based on the measurement resource to acquire the measurement result. The measurement result may indicate an impact of a transmit behavior of the terminal device over the first frequency band on the receive sensitivity of the terminal device over the second frequency band. In this way, the terminal device is allowed to determine, via measurement, an interference situation caused by one frequency band to the receive sensitivity over another frequency band. Consequently, the interference situation may be determined with respect to specific frequency bands, which eliminates the need to report interference for all possible band combinations. Furthermore, the accuracy of the interference situation acquired via measurement is higher. Therefore, the technical solutions may improve the accuracy of inter-band interference for the terminal device, and reduce the overhead of interference reporting.

FIG. 6 is a flowchart of a processing method for measurement according to some embodiments of the present disclosure. The method may be performed by a network device. The network device may be the network device 110 in the network architecture illustrated in FIG. 1. The method may include the following step.

In S610, the network device transmits configuration information to a terminal device, wherein the configuration information is used to configure a measurement resource for the terminal device, and the measurement resource is a time-frequency resource where no downlink signal is present; wherein the measurement resource is used by the terminal device to acquire a measurement result by measuring a received signal, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

In summary, in the technical solutions according to the embodiments of the present disclosure, regarding two operating frequency bands in which the terminal device operates, the network device may configure the time-frequency resource where no downlink signal is present as the measurement resource for the terminal device. The terminal device may measure the received signal based on the measurement resource to acquire the measurement result. The measurement result may indicate an impact of a transmit behavior of the terminal device over the first frequency band on the receive sensitivity of the terminal device over the second frequency band. In this way, the terminal device is allowed to determine, via measurement, an interference situation caused by one frequency band to the receive sensitivity over another frequency band. Consequently, the interference situation may be determined with respect to specific frequency bands, which eliminates the need to report interference for all possible band combinations. Furthermore, the accuracy of the interference situation acquired via measurement is higher. Therefore, the technical solutions may improve the accuracy of inter-band interference for the terminal device, and reduce the overhead of interference reporting.

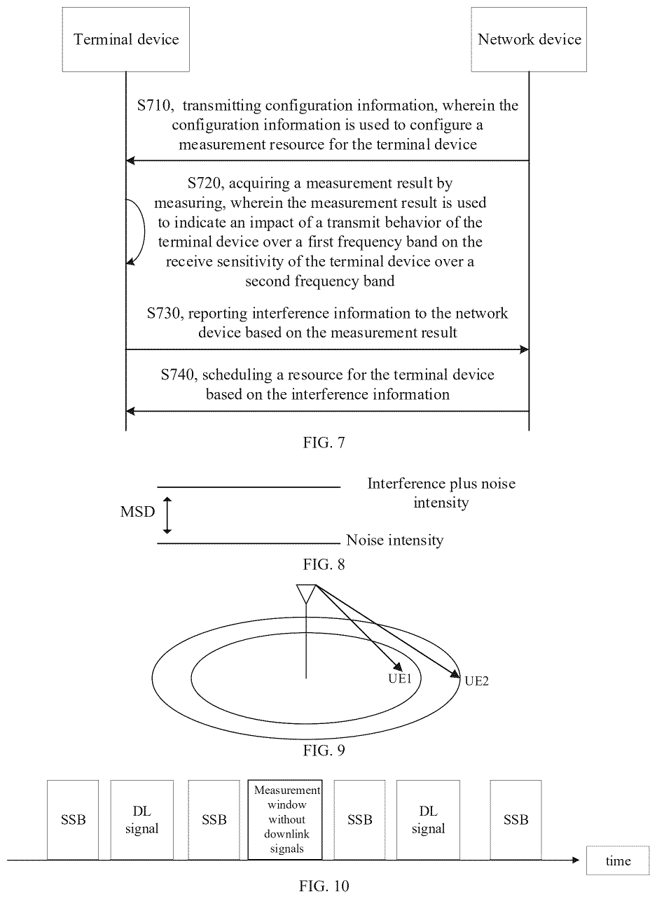

FIG. 7 is a flowchart of a processing method for measurement according to some embodiments of the present disclosure. The method may be performed interactively by a terminal device and a network device. The terminal device may be the terminal device 120 or the terminal device 130 in the network architecture illustrated in FIG. 1, and the network device may be the network device 110 in the network architecture illustrated in FIG. 1. The method may include the following steps.

In S710, the network device transmits configuration information to the terminal device, the terminal device receives the configuration information, wherein the configuration information is used to configure a measurement resource for the terminal device, the measurement resource being a time-frequency resource where no downlink signal is present.

In some embodiments, the network device may transmit the configuration information via signaling such as radio resource control (RRC) signaling or a medium access control (MAC) control element (CE).

In some embodiments, the network device may also transmit the configuration information via other messages besides signaling such as the RRC signaling or the MAC CE.

The configuration information may indicate the measurement resource in a semi-persistent manner or a dynamic manner.

In S720, the terminal device acquires a measurement result by measuring a received signal based on the measurement resource, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

In some embodiments, the configuration information is used to indicate time corresponding to the measurement resource. For example, the frequency of the measurement resource may be predefined, or indicated by the network device to the terminal device via other information besides the configuration information. Alternatively, the configuration information is used to indicate time and frequency corresponding to the measurement resource.

In the embodiments of the present disclosure, by indicating the time, or by indicating both the time and the frequency, the network device may indicate the measurement resource to the terminal device. This may expand the indication method for the measurement resource and improve the flexibility of the measurement resource indication.

In some embodiments, in a case where the configuration information is used to indicate the time and the frequency corresponding to the measurement resource, the measurement resource includes at least two time-frequency resources.

The at least two time-frequency resources may be time-frequency resources with the same time domain and different frequency domains, or the at least two time-frequency resources may be time-frequency resources with different time domains and the same frequency domain, or the at least two time-frequency resources may be time-frequency resources with different time domains and different frequency domains

In the embodiments of the present disclosure, intra-terminal interference in the time domains and the frequency domains is typically non-uniformly distributed. That is, the power of intra-terminal interference may be higher in some time domains and frequency domains, while the power of intra-terminal interference may be lower in other time domains and frequency domains. In the embodiments of the present disclosure, to avoid the impact of the non-uniformly distributed interference on the measurement result, in a case where the configuration information is used to indicate the time and the frequency corresponding to the measurement resource, the configuration information may indicate a plurality of time-frequency resources with different time domains and/or different frequency domains. Correspondingly, in a case where the terminal device measures the received signal, the terminal device may measure the received signal respectively over each of the plurality of time-frequency resources to acquire measurement results corresponding to each of the plurality of time-frequency resources. In some embodiments, the terminal device may also average the measurement results corresponding to each of the plurality of time-frequency resources to acquire the measurement result corresponding to the measurement resource.

In some embodiments, in a case where the configuration information is used to indicate the time corresponding to the measurement resource, the measurement resource may also include at least two time-frequency resources. For example, the configuration information is used to indicate a plurality of time domains, each of the plurality of time domains corresponding to one of the time-frequency resources. For example, the terminal device may form a plurality of time-frequency resources by combining each of the plurality of time domains indicated by the configuration information with all or part of the frequency domain resources within the second frequency band. Correspondingly, in a case where the terminal device measures the received signal, the terminal device may measure the received signal respectively over each of the plurality of time-frequency resources to acquire measurement results corresponding to each of the plurality of time-frequency resource. In some embodiments, the terminal device may also perform averaging processing on the measurement results corresponding to each of the plurality of time-frequency resources to acquire the measurement result corresponding to the measurement resource.

In some embodiments, in a case where the configuration information is used to indicate the time corresponding to the measurement resource, the measurement resource may also include a contiguous time-frequency resource. That is, the configuration information is used to indicate a contiguous period of time. Based on the contiguous period of time indicated by the configuration information and all or part of the frequency domain resources within the second frequency band, the terminal device may form the contiguous time-frequency resource. Alternatively, the duration of the contiguous period of time indicated by the configuration information may be greater than or equal to twice the duration required for the terminal device to perform a single measurement of the received signal. For example, the duration of the contiguous period of time indicated by the configuration information may be N times the duration required for the terminal device to perform a single measurement of the received signal, wherein Nis an integer greater than or equal to 2. Correspondingly, in a case where the terminal device measures the received signal based on the measurement resource, the terminal device may measure the received signal N times on the measurement resource to acquire N measurement results. In some embodiments, the terminal device may also perform averaging processing on the N measurement results to acquire the measurement result corresponding to the measurement resource.

In some embodiments, the configuration information is further used to indicate at least one of the first frequency band or the second frequency band.

The first frequency band and the second frequency band may be indicated by the network device via the configuration information, such that the network device indicates the terminal device to measure intra-terminal interference for specific frequency bands, rather than measuring intra-terminal interference for all possible band combinations. Therefore, the efficiency of intra-terminal interference measurement is improved and the utilization of communication resources is increased.

In some embodiments, acquiring the measurement result by measuring the received signal based on the measurement resource includes: acquiring a noise intensity by measuring the received signal on the measurement resource in a case where the terminal device does not perform signal transmission; acquiring an interference-plus-noise intensity by measuring the received signal on the measurement resource in a case where the terminal device performs signal transmission over the first frequency band and/or the second frequency band; and acquiring the measurement result based on the noise intensity and the interference-plus-noise intensity.

In the embodiments of the present disclosure, the measurement resource is the time-frequency resource where no downlink signal is present. Therefore, the impact from the downlink signal on the measurement result may be avoided. In this case, during measurement of the received signal on the measurement resource, the noise intensity may be acquired in a case where the terminal device does not perform signal transmission. Correspondingly, during measurement of the received signal on the measurement resource, the measured signal may include, in addition to the noise, the intra-terminal interference (i.e., the interference caused by the transmit behavior of the terminal device over the first frequency band on the reception sensitivity over the second frequency band) intensity and the noise intensity in a case where the terminal device performs signal transmission over the first frequency band and/or the second frequency band. The difference between the two measurement results is the intra-terminal interference intensity.

That is, in the embodiments in the present disclosure, the terminal device acquires the noise intensity and the interference-plus-noise intensity via a two-stage measurement. The terminal device acquires the noise intensity by measuring the received signal in a case where the terminal device does not perform signal transmission, and then the terminal device acquires the interference-plus-noise intensity by measuring the received signal in a case where the terminal device performs signal transmission over the first frequency band and/or the second frequency band. This process may ensure the accuracy of the intra-terminal interference measurement.

In some embodiments, the measurement result includes the noise intensity and the interference-plus-noise intensity; and/or the measurement result includes the MSD value, wherein the MSD value is determined based on a difference between the interference-plus-noise intensity and the noise intensity.

In S730, the terminal device reports interference information to the network device based on the measurement result, and the network device receives the interference information that is reported by the terminal device based on the measurement result.

In some embodiments, the interference information includes at least one of: the noise intensity and the interference-plus-noise intensity; a level of the noise intensity and a level of the interference-plus-noise intensity; the MSD value; a level of the MSD value; or a level range containing the level of the MSD value.

The noise intensity is acquired by the terminal device by measuring the received signal on the measurement resource in a case where the terminal device does not perform signal transmission. The interference-plus-noise intensity is acquired by the terminal device by measuring the received signal on the measurement resource in a case where the terminal device performs signal transmission over the first frequency band and/or the second frequency band. And the MSD value is determined based on a difference between the interference-plus-noise intensity and the noise intensity.

In S740, the network device schedules a resource for the terminal device based on the interference information.

In a case where the interference, such as the harmonic interference or the intermodulation interference, exists in the band combination, the interference may lead to significant sensitivity degradation, resulting in a difficulty in effectively utilizing the band combination in actual networks. In practice, with respect to different interference types, the terminals may adopt various measures to suppress the interference, such as adding filters or increasing the PCB isolation. Furthermore, different terminals may have different design methods. Consequently, in the actual network, with respect to the same band combination subject to mutual transmit-receive interference, the actual interference intensity varies among different terminals. To report the actual interference situation of the terminals to the base station such that the base station is allowed to selectively configure the band combination and resource configuration, the following section introduces this solution from the perspective of measuring the actual interference intensity at the terminal in the network.

### 1. Regarding Interference Types and Interference Order Information

For a band combination consisting of bands A+B+C, possible interference types include the harmonic interference, the intermodulation interference, out-of-band leakage interference (where the transmit frequency of band A is close to the receive frequency of band B, and the transmission over band A interferes with the reception over band B due to insufficient isolation), harmonic mixing interference, or the like. Different orders of interference may exist within each interference type. For example:
Harmonic interference includes second harmonic (twice the transmit frequency), third harmonic (three times the transmit frequency), fourth harmonic, fifth harmonic, and the like.
Intermodulation interference includes third-order intermodulation (2*F1±F2 or F1±2*F2), fifth-order intermodulation (3*F1±2*F2 or 2*F1±3*F2 or 4*F1±F2 or F1±4*F2), and the like. (Note: Intermodulation signals also include even-order interference such as second-order and fourth-order intermodulation).

Similarly, the harmonic mixing interference also includes second-order interference, third-order interference, fourth-order interference, and other orders of interference.

### 2. Regarding the Theoretical Basis for Real-Time Interference Measurement

The MSD characterizes a difference between the sensitivity of the terminal under interference and the sensitivity without interference. In a case where demodulation signal-to-noise ratio capability of the terminal remains unchanged, the MSD also effectively represents the difference between the interference intensity of the terminal and a noise floor of the terminal. This may be simply expressed as: (interference intensity+noise floor)−noise floor, expressed in unit of dB. FIG. 8 is a schematic diagram of the MSD involved in the present disclosure, which may simply represent the meaning of the MSD.

Therefore, in the network, as long as the terminal may acquire noise power and interference-plus-noise power (or noise-plus-interference power) for a band combination by measurement, the MSD may be acquired. However, the current measurement results of the terminal are based on the measurement of the intensity of the downlink signal. That is, the measurement signal includes the intensity of the downlink signal transmitted by the base station. FIG. 9 is a schematic diagram of terminal measurement of received signal intensity involved in the present disclosure. As illustrated in FIG. 9, the downlink signal intensity is not a constant value but varies depending on factors such as the distance between the terminal and the base station.

In the presence of interference signals, the received signal intensity=downlink signal power+interference power+noise power. The latter two are useful powers that need to be measured, whereas the downlink signal power is an unwanted power that needs to be removed. One method is to allow the base station to configure the terminal to measure the received power over the time-frequency resource where no downlink signal is present. In this case, the received signal power without the downlink signal (the noise power or the noise-plus-interference power) may be measured.

### 3. Regarding the Downlink Signal Measurement Time Window

As mentioned above, the downlink signal power from the base station is an unwanted signal that needs to be removed for MSD measurement. The removal of the unwanted signal is implemented by the base station configuring an appropriate measurement window and a measurement target resource for the terminal.

From a time perspective, as illustrated in FIG. 10, which is a schematic diagram of a downlink signal measurement time window involved in the present disclosure, typically, the base station periodically transmits system broadcast messages (e.g., synchronization signal and physical broadcast channel (PBCH) block (SSB)), downlink services, and downlink control information on the downlink. To avoid the impact from these downlink signals on the noise floor and the interference intensity, the base station may select time periods where no downlink signal is present to configure the measurement window. In general, in addition to the downlink signals affecting the noise floor and the interference noise for the terminal, uplink signals transmitted by other terminals may also cause an increase in the noise floor. Compared to the impact from the downlink signals, the impact from the uplink signals is relatively limited. The impact from the uplink signals may be either ignored during measurement window configuration, or the measurement window may be configured to a time period where neither uplink signals nor downlink signals are present. However, these measurement window configurations may not mitigate burst interference. To mitigate the burst interference, the measurement time window for the terminal may be extended or configured the time window across a plurality of slots.

The burst interference refers to a type of interference that is short in duration and does not occur repeatedly. The impact from this interference on the measurement result is transient. In embodiments of the present disclosure, by extending the measurement time window or configuring the window across a plurality of slots, the terminal device may average out the impact from short-term interference during measurement. This reduces its effect on the accuracy of the measurement result. For example, in a case where the measurement time window is extended, the terminal device may acquire an average measurement result over a longer period on the measurement resource. Alternatively, the terminal device may measure the received signal multiple times on the measurement resource to acquire an average result on the measurement resource. For example, in a case where windows are configured across a plurality of slots (i.e., in a case where the measurement resource includes a plurality of non-contiguous resources in the time domain), the terminal device may measure the received signal separately on each of the plurality of non-contiguous resources and then average the results to acquire the average measurement result across the measurement resources.

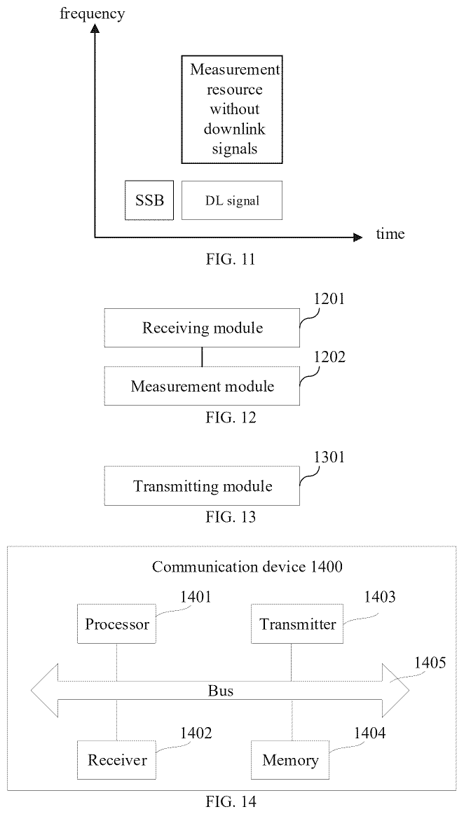

From a time-frequency resource perspective, as illustrated in FIG. 11, which is a schematic diagram of a downlink signal measurement time-frequency resource involved in the present disclosure, the base station separates time-frequency resources for terminal measurement from the downlink signals such as broadcast signals. By performing measurement on these target time-frequency signals by the terminal, the impact from the downlink signals on the measurement results are mitigated. In this method, the target measurement resources are typically limited in the frequency domain. In some cases, the interference signals at the terminal are non-uniformly distributed, and thus the terminal needs to measure the received signal across a plurality of target time-frequency resources to acquire an average interference intensity. For example, the plurality of target time-frequency resources may be a plurality of resources in the same time domain but different frequency domains. Upon measuring the received signals on the plurality of target time-frequency resources, the terminal device averages the results to acquire the measurement result. This may solve the problem of measurement inaccuracy caused by non-uniformly distributed interference in the frequency domain. Alternatively, the plurality of target time-frequency resources may be a plurality of resources in the same frequency domain but different time domains. Upon measuring the received signals on the plurality of target time-frequency resources, the terminal device averages the results to acquire the measurement result. This may solve the problem of measurement inaccuracy caused by non-uniformly distributed interference in the time domain. Alternatively, the plurality of target time-frequency resources may be a plurality of resources in different frequency domains and different time domains. Upon measuring the received signals on the plurality of target time-frequency resources, the terminal device averages the results to acquire the measurement result. This may solve the problem of measurement inaccuracy caused by non-uniformly distributed interference in the frequency domain and the time domain.

### 4. Regarding the Interference Measurement Process

Taking a band combination of band A+band B as an example, where the harmonic of a transmit signal over band A interferes with downlink reception over band B. To understand the actual interference situation of the terminal under the band combination, the base station may configure the terminal to measure the received signal intensity under both harmonic interference and non-harmonic interference scenarios. The details are as follows:

The base station configures the downlink signal measurement time-frequency resources to the terminal, and the terminal acquires the noise power by measuring the noise over band B.

The base station configures the band combination of band A+band B to the terminal, and based on the interference generation mechanism, the base station activates band A, band B, or both band A and band B simultaneously to generate the interference signal for the terminal to measure interference intensity.

Regarding the example where a harmonic of a transmit signal over band A interferes with reception over band B, only the transmission over band A needs to be activated herein. In the case of intermodulation interference, for example, where intermodulation of band A and band B interferes with reception over band B, then transmit signals over both band A and band B need to be activated simultaneously.

The terminal acquires the interference+noise power by measuring the received signal intensity under interference conditions.

The terminal reports the interference intensity information. The interference signal intensity information may be the noise power and the interference+noise power acquired from the measurements, or the difference (which may represent the MSD value) between the noise power and the interference+noise power.

The noise power and the interference+noise power may be a received signal strength indicator (RSSI) values measured by the terminal on the target measurement resource, or may be separate measurement parameters.

### 5. Result Reporting

In a case where the measurement results are noise power and interference+noise power, the reported value is a power value. The reporting may be performed by reporting the actual result directly, or mapping the power to a corresponding interval before reporting. Details are as follows:

In a case where the terminal device reports the actual result (hereinafter represented by the power level), the reported value (Pow_xx) may be listed in Table 1.

TABLE 1

| Reported value | Measurement value | Unit |
|---|---|---|
| Pow_00 | Power level < −100 | Decibel-milliwatt (dBm) |
| Pow_01 | −100 ≤ Power level < −99 | dBm |
| Pow_02 | −99 ≤ Power level < −98 | dBm |
| . . . | . . . | . . . |
| Pow_aa | −48 ≤ Power level < −49 | dBm |
| Pow_bb | −49 ≤ Power level < −50 | dBm |
| Pow_cc | −50 ≤ Power level | dBm |

In a case where the terminal device reports the MSD (hereinafter represented by the MSD level), the reported value (MSD_xx) may be listed in Table 2.

TABLE 2

| Reported value | Measurement value | Unit |
|---|---|---|
| MSD_00 | MSD level = 0 | Decibel (dB) |
| MSD_01 | 0 < MSD level ≤ 1 | dB |
| MSD_02 | 1 < MSD level ≤ 2 | dB |
| . . . | . . . | . . . |
| MSD_aa | 38 < MSD level ≤ 39 | dB |
| MSD_bb | 39 < MSD level ≤ 40 | dB |
| MSD_cc | 40 ≤ MSD level | dB |

Alternatively, the terminal device may report the MSD result at predefined intervals. As listed in Table 3, a 3 dB step size is used to identify the interval containing the actual MSD value, and the terminal device may report the capability class corresponding to the interval, thereby reducing signaling overhead.

TABLE 3

| | | |
|---|---|---|
| Lower MSD | Maximum allowed | |
| Capability | actual MSD | |
| classes | (i.e., thresholds) | Note |

| | | | |
|---|---|---|---|
| 1 | 0 | dB | No degradation |
| 2 | 3 | dB | Actual MSD ≤ 3 dB |
| 3 | 6 | dB | Actual MSD ≤ 6 dB |
| 4 | 9 | dB | Actual MSD ≤ 9 dB |
| 5 | 12 | dB | Actual MSD ≤ 12 dB |
| 6 | 15 | dB | Actual MSD ≤ 15 dB |
| 7 | 18 | dB | Actual MSD ≤ 18 dB |
| 8 | 22 | dB | Actual MSD ≤ 22 dB |

| | | |
|---|---|---|
| . . . | . . . | . . . |

### 6. The Processing Method for the Base Station

Upon receiving the interference intensity indication (the noise power and the interference+noise power, or the MSD value) that is reported by the terminal, the base station may determine the interference intensity of the band combination in the current scenario. For band combinations subject to low interference, the base station may use the capability information to decide whether to configure the band combination and to schedule or avoid scheduling some resource combinations.

In a case where the base station receives an interference intensity value, the base station may calculate the MSD value (i.e., (interference+noise power)−noise power).

For band combinations subject to high interference for the terminal, the base station may take measures to mitigate the interference. For example, for band combination A+B, wherein band A causes harmonic interference to band B. The base station may avoid, by scheduling, simultaneous transmission on band A and reception on band B by the terminal. As another example, for band combination A+B+C, the intermodulation interference from A+B affects band C. The base station may mitigate intermodulation interference to band C by preventing simultaneous transmission on bands A and band B. Therefore, the actual interference measurement and reporting by the terminal may notify actual interference conditions for the terminal to the base station, thereby assisting the base station in scheduling, avoiding interference, and improving throughput.

Compared to the related reporting method based on the terminal MSD capability information, the technical solution illustrated in the present disclosure involves a reporting method based on real-time measurement of the MSD or the interference intensity. This solution may simplify the implementation complexity of the terminal and reduce the signaling overhead. Meanwhile, the terminal does not need to identify interference types or interference frequency band information. The terminal may perform interference/MSD assessment by following the interference measurement window and the interference reporting configuration configured by the base station, which simplifies the process, and improves the efficiency of the process. Similarly, the base station does not need to memorize interference types, interference MSD values, or interference frequencies for various band combinations. The base station only needs to configure the terminal to measure and report the corresponding frequency points within the corresponding band combination to know the actual interference conditions of the terminal, which is highly convenient.

FIG. 12 is a block diagram of a processing apparatus for measurement according to some embodiments of the present disclosure. The processing apparatus for measurement implements the functions implemented by the terminal device in any of the methods illustrated in FIG. 5 to FIG. 7. As illustrated in FIG. 12, the apparatus may include a receiving module 1201 and a measurement module 1202.

The receiving module 1201 is configured to receive configuration information, wherein the configuration information is used to configure a measurement resource for the terminal device, the measurement resource being a time-frequency resource where no downlink signal is present.

The measurement module 1202 is configured to acquire a measurement result by measuring a received signal based on the measurement resource, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

In some embodiments, the configuration information is used to indicate time corresponding to the measurement resource; or the configuration information is used to indicate time and frequency corresponding to the measurement resource.

In some embodiments, in a case where the configuration information is used to indicate the time and the frequency corresponding to the measurement resource, the measurement resource includes at least two time-frequency resources.

In some embodiments, the configuration information is further used to indicate at least one of the first frequency band or the second frequency band.

In some embodiments, the measurement module 1202 is further configured to: acquire a noise intensity by measuring the received signal on the measurement resource in a case where the terminal device does not perform signal transmission; acquire an interference-plus-noise intensity by measuring the received signal on the measurement resource in a case where the terminal device performs signal transmission over the first frequency band and/or the second frequency band; and acquire the measurement result based on the noise intensity and the interference-plus-noise intensity.

In some embodiments, the measurement result includes the noise intensity and the interference-plus-noise intensity; and/or the measurement result includes an MSD value, wherein the MSD value is determined based on a difference between the interference-plus-noise intensity and the noise intensity.

In some embodiments, the apparatus further includes a transmitting module, configured to report interference information to a network device based on the measurement result.

In some embodiments, the interference information includes at least one of: the noise intensity and the interference-plus-noise intensity; a level of the noise intensity and a level of the interference-plus-noise intensity; the MSD value; a level of the MSD value; or a level range containing the level of the MSD value.

FIG. 13 is a block diagram of a processing apparatus for measurement according to some embodiments of the present disclosure. The processing apparatus for measurement implements the functions implemented by the network device in any of the methods illustrated in FIG. 5 to FIG. 7. As illustrated in FIG. 13, the apparatus may include a transmitting module 1301.

The transmitting module 1301 is configured to transmit configuration information to a terminal device, wherein the configuration information is used to configure a measurement resource for the terminal device, the measurement resource being a time-frequency resource where no downlink signal is present; wherein the measurement resource is used by the terminal device to acquire a measurement result by measuring a received signal, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

In some embodiments, the configuration information is used to indicate time corresponding to the measurement resource; or the configuration information is used to indicate time and frequency corresponding to the measurement resource.

In some embodiments, in a case where the configuration information is used to indicate the time and the frequency corresponding to the measurement resource, the measurement resource includes at least two time-frequency resources.

In some embodiments, the configuration information is further used to indicate at least one of the first frequency band or the second frequency band.

In some embodiments, the apparatus further includes a receiving module, configured to receive interference information that is reported by the terminal device based on the measurement result.

In some embodiments, the interference information includes at least one of: a noise intensity and an interference-plus-noise intensity; a level of the noise intensity and a level of the interference-plus-noise intensity; an MSD) value; a level of the MSD value; or a level range containing the level of the MSD value; wherein the noise intensity is acquired by the terminal device by measuring the received signal on the measurement resource in a case where the terminal device does not perform signal transmission; the interference-plus-noise intensity is acquired by the terminal device by measuring the received signal on the measurement resource in a case where the terminal device performs signal transmission over the first frequency band and/or the second frequency band; and the MSD value is determined based on a difference between the interference-plus-noise intensity and the noise intensity.

In some embodiments, the apparatus further includes a scheduling module, configured to schedule a resource for the terminal device based on the interference information.

It should be noted that when implementing the functions of the apparatus according to the above embodiments, the organization of the various functional modules is merely exemplary. In practical applications, the above functions may be assigned to different functional modules according to actual needs, i.e., in terms of content and structure, the device may be partitioned into different functional modules to accomplish all or part of the above functions.

With regard to the apparatus in the above embodiments, the specific mode in which each module performs the operation has been described in detail in the embodiments related to the method, which is not described herein any further.

FIG. 14 is a schematic structural diagram of a communication device 1400 according to some embodiments of the present disclosure. The communication device 1400 includes a processor 1401, a receiver 1402, a transmitter 1403, a memory 1404, and a bus 1405.

The processor 1401 includes one or more processing cores, and achieves various functional applications and information processing by running software programs and modules.

The receiver 1402 and the transmitter 1403 are practiced as a communication assembly. The communication assembly is a communication chip. The communication chip may also be referred to as a transceiver. The memory 1404 is connected to the processor 1401 via the bus 1405. The memory 1404 is configured to store one or more computer programs, and the processor 1401, when loading and executing the one or more computer programs, is caused to perform various processes in the above method embodiments.

In addition, the memory 1404 is practiced by any type of volatile or non-volatile storage device or combinations thereof. The volatile or non-volatile storage device includes but is not limited to a disk or optical disc, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

In some embodiments, in a case where the communication device 1400 is implemented as the terminal device, the receiver 1402 and the processor 1401 execute the one or more computer programs to cause the communication device to implement various steps performed by the terminal device in any one of the methods illustrated in FIG. 5 to FIG. 7.

In some embodiments, in a case where the communication device 1400 is implemented as the network device, the receiver 1402 and the processor 1401 execute the one or more computer programs to cause the communication device to implement various steps performed by the network device in any one of the methods illustrated in FIG. 5 to FIG. 7.

Some embodiments of the present disclosure provide a computer-readable storage medium. The computer-readable storage medium stores one or more computer programs, wherein the one or more computer programs, when loaded and run by a processor, cause the processor to perform all or part of the steps performed by the terminal device or the network device in any one of the methods illustrated in FIG. 5 to FIG. 7.

Some embodiments of the present disclosure provide a chip. The chip is configured to run in a communication device to cause the communication device to perform all or part of the steps performed by the terminal device or the network device in any one of the methods illustrated in FIG. 5 to FIG. 7.

Some embodiments of the present disclosure provide a computer program product. The computer program product or computer program includes: one or more computer instructions stored in a computer-readable storage medium, wherein the one or more computer instructions, when read from the computer-readable storage medium and executed by a processor of a communication device, cause the communication device to perform all or part of the steps performed by the terminal device or the network device in any one of the methods illustrated in FIG. 5 to FIG. 7.

Some embodiments of the present disclosure provide a computer program. The computer program, when loaded and run by a processor of a communication device, causes the communication device to perform all or part of the steps performed by the terminal device or the network device in any one of the methods illustrated in FIG. 5 to FIG. 7.

Those skilled in the art should be aware that in the above one or more examples, the functions described in the embodiments of the present disclosure may be implemented by hardware, software, firmware, or any combination thereof. When implemented by software, these functions may be stored on a computer-readable medium or transmitted as one or more instructions or codes on a computer-readable medium. A computer-readable medium includes a computer storage medium and a communication medium, wherein the communication medium includes any medium that facilitates the transfer of a computer program from one place to another. The storage medium may be any available medium that may be accessed by a general-purpose or special-purpose computer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described above are only embodiments of the present disclosure, which are not intended to limit the present disclosure. Any modifications, equivalent replacements, improvements, and the like, made in the spirit and principles of the present disclosure should be included in the protection scope of the present disclosure.

1. A processing method for measurement, performed by a terminal device, the method comprising:
receiving configuration information, wherein the configuration information is used to configure a measurement resource for the terminal device, the measurement resource being a time-frequency resource where no downlink signal is present; and
acquiring a measurement result by measuring a received signal based on the measurement resource, wherein the measurement result is used to indicate an impact of a transmit behavior of the terminal device over a first frequency band on the receive sensitivity of the terminal device over a second frequency band;
wherein the second frequency band is a frequency band corresponding to the measurement resource, and the first frequency band is different from the second frequency band.

2. The method according to claim 1, wherein:
the configuration information is used to indicate time corresponding to the measurement resource; or
the configuration information is used to indicate time and frequency corresponding to the measurement resource.

3. The method according to claim 2, wherein in a case where the configuration information is used to indicate the time and the frequency corresponding to the measurement resource, the measurement resource comprises at least two time-frequency resources.

4. The method according to claim 1, wherein the configuration information is further used to indicate at least one of the first frequency band or the second frequency band.

5. The method according to claim 1, wherein acquiring the measurement result by measuring the received signal based on the measurement resource comprises:
acquiring a noise intensity by measuring the received signal on the measurement resource in a case where the terminal device does not perform signal transmission;
acquiring an interference-plus-noise intensity by measuring the received signal on the measurement resource in a case where the terminal device performs signal transmission over at least one of the first frequency band or the second frequency band; and
acquiring the measurement result based on the noise intensity and the interference-plus-noise intensity.

6. A terminal device, comprising:
a processor, a memory, and a transmitter;
wherein the memory is configured to store one or more computer programs, which when executed by the processor, cause the terminal device to:
receive configuration information, wherein the configuration information is used to configure a measurement resource for the terminal device, the measurement resource being a time-frequency resource where no downlink signal is present; and
acquire a measurement result by measuring a received signal based on the measurement resource, wherein the measurement result is used to indicate an impact of a transmit behavior of the terminal device over a first frequency band on the receive sensitivity of the terminal device over a second frequency band;
wherein the second frequency band is a frequency band corresponding to the measurement resource, and the first frequency band is different from the second frequency band.

7. The terminal device according to claim 6, wherein:
the configuration information is used to indicate time corresponding to the measurement resource; or
the configuration information is used to indicate time and frequency corresponding to the measurement resource.

8. The terminal device according to claim 7, wherein in a case where the configuration information is used to indicate the time and the frequency corresponding to the measurement resource, the measurement resource comprises at least two time-frequency resources.

9. The terminal device according to claim 6, wherein the configuration information is further used to indicate at least one of the first frequency band or the second frequency band.

10. The terminal device according to claim 6, wherein the one or more computer programs, which when executed by the processor, further cause the terminal device to:
acquire a noise intensity by measuring the received signal on the measurement resource in a case where the terminal device does not perform signal transmission;
acquire an interference-plus-noise intensity by measuring the received signal on the measurement resource in a case where the terminal device performs signal transmission over at least one of the first frequency band or the second frequency band; and
acquire the measurement result based on the noise intensity and the interference-plus-noise intensity.

11. The terminal device according to claim 10, wherein:
the measurement result comprises the noise intensity and the interference-plus-noise intensity; and/or
the measurement result comprises a maximum sensitivity degradation (MSD) value, wherein the MSD value is determined based on a difference between the interference-plus-noise intensity and the noise intensity.

12. The terminal device according to claim 11, wherein the one or more computer programs, which when executed by the processor, further cause the terminal device to:
report interference information to a network device based on the measurement result.

13. The terminal device according to claim 12, wherein the interference information comprises at least one of:
the noise intensity and the interference-plus-noise intensity;
a level of the noise intensity and a level of the interference-plus-noise intensity;
the MSD value;
a level of the MSD value; or
a level range containing the level of the MSD value.

14. A network device, comprising:
a processor, a memory and a transmitter;
wherein the memory is configured to store one or more computer programs, which when executed by the processor, cause the network device to:
transmit configuration information to a terminal device, wherein the configuration information is used to configure a measurement resource for the terminal device, the measurement resource being a time-frequency resource where no downlink signal is present;
wherein the measurement resource is used by the terminal device to acquire a measurement result by measuring a received signal, wherein the measurement result is used to indicate an impact of a transmit behavior of the terminal device over a first frequency band on the receive sensitivity of the terminal device over a second frequency band; wherein the second frequency band is a frequency band corresponding to the measurement resource, and the first frequency band is different from the second frequency band.

15. The network device according to claim 14, wherein:
the configuration information is used to indicate time corresponding to the measurement resource; or
the configuration information is used to indicate time and frequency corresponding to the measurement resource.

16. The network device according to claim 15, wherein in a case where the configuration information is used to indicate the time and the frequency corresponding to the measurement resource, the measurement resource comprises at least two time-frequency resources.

17. The network device according to claim 14, wherein the configuration information is further used to indicate at least one of the first frequency band or the second frequency band.

18. The network device according to claim 14, wherein the one or more computer programs, which when executed by the processor, further cause the network device to:
receive interference information that is reported by the terminal device based on the measurement result.

19. The network device according to claim 18, wherein the interference information comprises at least one of:
a noise intensity and an interference-plus-noise intensity;
a level of the noise intensity and a level of the interference-plus-noise intensity;
a maximum sensitivity degradation (MSD) value;
a level of the MSD value; or
a level range containing the level of the MSD value;
wherein the noise intensity is acquired by the terminal device by measuring the received signal on the measurement resource in a case where the terminal device does not perform signal transmission; the interference-plus-noise intensity is acquired by the terminal device by measuring the received signal on the measurement resource in a case where the terminal device performs signal transmission over at least one of the first frequency band or the second frequency band; and the MSD value is determined based on a difference between the interference-plus-noise intensity and the noise intensity.

20. The network device according to claim 18, wherein the one or more computer programs, which when executed by the processor, further cause the network device to:
schedule a resource for the terminal device based on the interference information.
